(19) United States
(12) Patent Application Publication
(10) Pub. No.: US 2012/0177793 A1
(43) Pub. Date: Jul. 12, 2012

(54) Low-calorie milk product

(76) Inventors: Peter H. Mattson, Hillsborough, CA (US); Wennie Mo, Palo Alto, CA (US); Angela Kristina Gil, Alameda, CA (US); Juan Carlos Feregrino Quezada, Aguascalientes (MX)

(21) Appl. No.: 13/065,586

(22) Filed: Mar. 23, 2011

Related U.S. Application Data
(60) Provisional application No. 61/340,938, filed on Mar. 23, 2010.

(51) Int. Cl. A23C 9/156; A23C 3/03; A23C 3/08

(52) U.S. Cl. 426/324; 426/584; 426/548; 426/330.2

(57) ABSTRACT

A sweetened low-calorie, low-fat milk beverage is produced by adding milk calcium, milk protein, sugar and a non-nutritive sweetener, as well as other ingredients, to nonfat dry milk. The product, in different flavors, has about 90 calories in an 8 ounce serving.

### BACKGROUND OF THE INVENTION

This application claims benefit of provisional application Ser. No. 61/340,938, filed Mar. 23, 2010.

This invention concerns milk beverages, in particularly a low-fat flavored milk product with the full nutritional benefits of whole milk.

A number of milk-based beverages have been marketed, including those with relatively low fat content. None, however, has had the desirable characteristics of low fat, low calories and sweet dairy flavor as in the product and invention described below.

### SUMMARY OF THE INVENTION

In the invention a low-calorie, low-fat milk beverage product exhibits a very pleasing dairy flavor, somewhat sweetened, and has all the calcium and milk protein of whole milk. Nonfat dry milk is the preferred source of milk ingredients. To this is added water, whey protein isolate, a stabilizer blend, an edible oil such as canola oil (or another vegetable oil such as soybean oil or safflower oil), calcium lactate (or other calcium fortifying ingredient to bring calcium content up to that of milk), a pH adjuster, salt, flavoring (such as vanilla, mocha or chocolate, etc.), and sweeteners, preferably including sugar, sucralose and a sweetener such as Sunett Ace K (acesulfame potassium). In a vanilla drink, for example, vanilla flavor is the flavoring agent, and titanium dioxide may be added to improve opacity of the liquid. Yellow color is added to produce a vanilla color in the drink. In the procedure for preparing the beverage, the stabilizer blend and sugar are pre-blended. The blend is then hydrated in the water using a high shear mixer for at least about ten minutes. Next, the remaining dry ingredients are blended and added into the mixer (including whey protein isolate, NFDM, calcium lactate, phosphate blend, salt, ACE K and cocoa, if present). The remaining ingredients are added: oil, sucralose and flavors (as well as titanium dioxide and yellow color, if present). The mix is blended for about ten minutes. The pH of the blended liquid is adjusted, which may be done with phosphate blend, to about pH 6.5 to 7.5.

The liquid mix is adjusted to solids, assuring the product has the desired amount of soluble solids, which is preferably about 9.5 to 10.5 Brix. The blended mix is then processed at an elevated temperature, which may be, for example, about 293° F. for a minimum of about two seconds, or equivalent, for antimicrobial treatment. This can be done in a Tetra Therm Aseptic VTIS Steam Injection Unit. This can also be done in a canning retort process. The product is then trim cooled, preferably to about 170° F., and then homogenized. The homogenized beverage is then cooled to about 80° F. and filled into bottles or other containers, unless the canning retort process is used.

### DESCRIPTION OF THE DRAWINGS

FIGS. 1, 2 and 3 are charts showing ingredients and procedure for vanilla, mocha and chocolate beverages, respectively, according to the invention.

### DESCRIPTION OF PREFERRED EMBODIMENTS

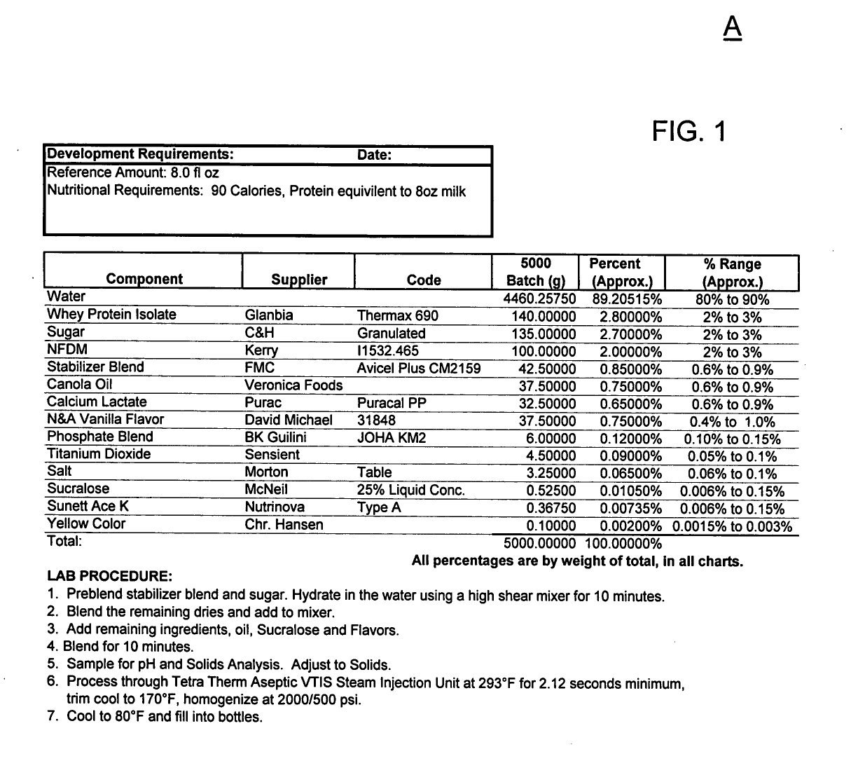

Charts A, B and C in FIGS. 1, 2 and 3 show examples of three different beverages of the invention, vanilla, mocha and milk chocolate, with preferred ingredients, amounts and percentages by weight of the total blended product. Example of sources of these components are also identified. Note that cocoa, although it provides flavor is not considered a flavoring in the claims. Cocoa also provides thickness and color and affects pH.

In these formulae, whey protein isolate serves as a protein source for the beverage. Sugar, sucralose and Ace K (acesulfame potassium) are all sweetening agents, and the proper balance of these three sweeteners is important to achieve proper taste. Sucralose and Ace K, both high-intensity, non-nutritive sweeteners, are more intense sweeteners than natural sugar, and they are present, as shown in the charts, in far lower concentrations. The ratios among the three as shown in these charts represent optimum results for flavor, for the particular beverage represented in each chart. Too much high-intensity sweetener produces an off-flavor, while too much sugar introduces too much in calories. Other high-intensity artificial sweetners can be substituted for sucralose and Ace K.

Nonfat dry milk (NFDM) is the source of milk ingredients, a dehydrated product stripped of fat. The stabilizer blend provides for a good mouthfeel, as well as suspension of ingredients such as whey protein isolate and nonfat dry milk.

Canola oil (or other edible oil) is included for mouthfeel, and calcium lactate (or other calcium fortifier such as milk mineral complex from Glanbia or calcium lactate gluconate) provides a source of calcium to equal at least the calcium found in whole milk, which is about 250-300 mg/cup (8 fl. oz.). The phosphate blend serves as a pH adjuster, in order to keep the proteins in an essentially neutral system so they will not come out of solution or precipitate. Preferred pH is about 6.5 to

7.5.

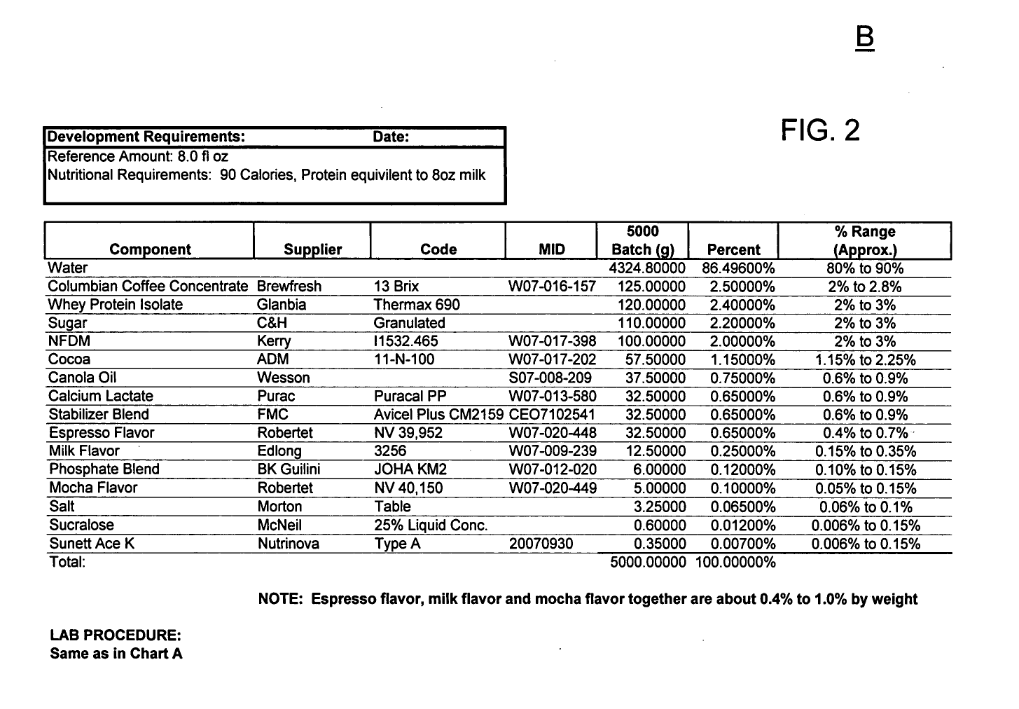

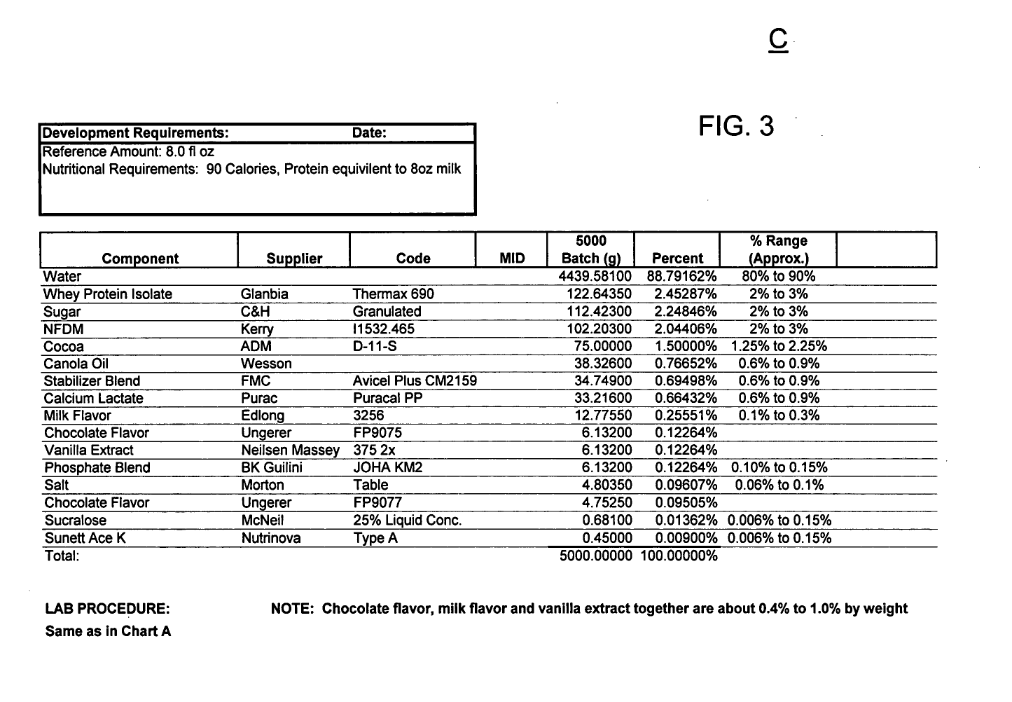

The flavorings in the three different examples represented in the charts of the drawings are vanilla (FIG. 1); coffee concentrate, espresso flavor, milk flavor (FIG. 2); and chocolate flavor, milk flavor and vanilla extract (FIG. 3). The latter two products also include cocoa powder.

One objective of the beverage of the invention is to provide the nutrients found in a serving of milk, while actually producing a beverage which will taste better than milk to most people. Ingredients such as the whey protein isolate and calcium lactate are included because the amount of nonfat dry milk per serving is not enough to equal the nutrient content in a glass of milk.

The above described preferred embodiments are intended to illustrate the principles of the invention, but not to limit its scope. Other embodiments and variations to these preferred embodiments will be apparent to those skilled in the art and may be made without departing from the spirit and scope of the invention as defined in the following claims.

We claim:

1. A low fat, low calorie flavored milk beverage, comprising, in a blended combination:
water, about 80% to 90% by weight,
whey protein isolate, about 2% to 3% by weight,
sugar, about 2% to 3% by weight,
nonfat dry milk, about 2% to 3% by weight,
stabilizer blend,
edible oil,
a calcium fortifying ingredient,
flavoring, at least about 0.4% by weight,
high-intensity, non-nutritive sweetener, about 0.01% to 0.3% by weight, and
a pH adjuster as needed to bring pH of the blended combination to about 6.5 to 7.5.

2. A flavored milk beverage according to claim 1, wherein the pH adjuster is a phosphate blend, about 0.10% to 0.15% by weight.

3. A flavored milk beverage according to claim 1, wherein the flavoring is vanilla.

4. A flavored milk beverage according to claim 3, further including titanium dioxide to increase opacity, about 0.05% to 0.1% by weight.

5. A flavored milk beverage according to claim 3, further including yellow color, about 0.0015% to 0.003% by weight.

6. A flavored milk beverage according to claim 1, further including salt, about 0.06% to 0.1% by weight.

7. A flavored milk beverage according to claim 1, wherein the edible oil comprises canola oil.

8. A flavored milk beverage according to claim 1, wherein the edible oil comprises soybean oil, canola oil or safflower oil.

9. A flavored milk beverage according to claim 1, wherein the high intensity, non-nutritive sweetener includes sucralose and acesulfame potassium.

10. A flavored milk beverage according to claim 1, wherein the flavored milk beverage is mocha flavor, and the flavoring includes coffee concentrate.

11. A flavored milk beverage according to claim 1, wherein flavored milk beverage is chocolate flavor, and the flavoring includes chocolate flavor, and further including cocoa.

12. A flavored milk beverage according to claim 1, wherein the stabilizer blend is included at about 0.6% to 0.9% by weight.

13. A flavored milk beverage according to claim 1, wherein the edible oil comprises canola oil at about 0.6% to 0.9% by weight.

14. A flavored milk beverage according to claim 1, wherein the calcium fortifying ingredient is in an amount sufficient to bring calcium content of the beverage up to about 250 to 350 mg per 8 fluid ounce serving.

15. A flavored milk beverage according to claim 1, wherein the calcium fortifying ingredient is calcium lactate and in an amount sufficient to bring calcium content of the beverage up to about 250 to 350 mg per 8 fluid ounce serving.

16. A flavored milk beverage according to claim 1, wherein the flavoring is included at about 0.4% to 1.0% by weight.

17. A method for producing a low-fat, low-calorie flavored milk beverage, comprising:
pre-blending a stabilizer blend and sugar,
mixing the stabilizer blend and sugar with water using a high shear mixer, producing a hydrated blend,
blending into the hydrated blend additional dry ingredients, including whey protein isolate, nonfat dry milk, a calcium fortifying ingredient, a pH adjuster and salt,
adding and blending an edible oil, high-intensity, non-nutritive sweetener and flavors,
adjusting pH and solids content as needed, to bring pH to a range of about 6.5 to 7.5 and solids content to a range of about 9.5 to 10.5 Brix,
heat processing the resulting blend for antimicrobial treatment, and homogenizing the blend.

18. The method of claim 17, wherein the heat processing step is performed using steam injection, at about 293° F. for a minimum of about 2 seconds, and wherein the blend after heat processing is cooled to a maximum temperature of about 170° F., then homogenized, followed by further cooling and filling the beverage into containers.
